(19) United States
(12) Patent Application Publication
(10) Pub. No.: US 2026/0079238 A1
(43) Pub. Date: Mar. 19, 2026

(54) METHOD FOR INCREASING DOPPLER RESOLUTION, METHOD FOR OPERATING A RADAR SENSOR, AND RADAR SENSOR

(71) Applicant: Robert Bosch GmbH, Stuttgart (DE)

(72) Inventors: Daniel Kaluza, Heilbronn (DE); Johannes Fink, Karlsruhe (DE)

(21) Appl. No.: 19/291,792

(22) Filed: Aug. 6, 2025

(30) Foreign Application Priority Data
Sep. 17, 2024 (DE) 10 2024 208 867.6

(51) Int. Cl. G01S 7/35; G01S 13/58

(52) U.S. Cl. CPC G01S 7/356; G01S 13/584

(57) ABSTRACT

A method for increasing Doppler resolution in a selection range of a signal spectrum of a radar signal from a radar sensor. A method for operating a radar sensor, and a radar sensor, are also described.

### CROSS REFERENCE

The present application claims the benefit under 35 U.S.C. § 119 of Germany Patent Application No. DE 10 2024 208 867.6 filed on Sep. 17, 2024, which is expressly incorporated herein by reference in its entirety.

### FIELD

The present invention relates to a method for increasing Doppler resolution. The present invention also relates to a method for operating a radar sensor and a radar sensor.

### BACKGROUND INFORMATION

The radar sensors commonly used in vehicles use specific types of transmission signals that are transmitted and received in a cyclic sequence. The transmitted signals are divided into time windows during which the radar sensor emits the transmission signals. A well-known example of such a radar signal is the linear chirp sequence frequency modulated continuous wave (LCS-FMCW). The signal is transmitted for the duration of a time window, and after the time window has elapsed, a pause time is observed before the next time window begins. This pause time is needed to enable a distinction between the transmission signals from successive time windows in the received signals and at the same time reduce the thermal load on the radar sensor. The time period between the start of a time window and the start of the next time window is typically referred to as the cycle time. The ratio between the duration of a time window and the total cycle time is called the duty cycle. In modern radar sensors, the duty cycle is typically less than 50%, which means that the radar sensor actually transmits for less than half the time and pauses transmission for the rest of the time in order to reduce the thermal load, enable multiplexing and free up time for the computation process.

A key aspect of radar sensors is Doppler separation capability. This describes the ability of the radar sensor to detect small differences in the Doppler frequency of two radar echoes, which is crucial for distinguishing different objects having similar velocities from one another. The Doppler frequency itself is correlated directly with the relative velocity of an object with respect to the radar sensor. The Doppler frequency becomes increasingly higher the faster an object is moving toward the radar sensor and lower as the object moves away from the radar sensor.

The Doppler separation capability is inversely proportional to the coherent integration time, i.e., the time over which the radar sensor integrates the received signals in phase. The coherent integration time is typically at most as long as the duration of a time window, because only one time window is analyzed per processing cycle. The Doppler separation capability is therefore limited by the length of the time window.

### SUMMARY

According to the present invention, a method for increasing Doppler resolution in a selection range of a signal spectrum of a radar signal from a radar sensor resulting from a cyclic sequence of time windows in which transmission signals are transmitted, is provided. According to an example embodiment of the present invention, the method includes providing at least a first and second signal spectrum of the radar sensor, each of which is spanned at least by the distance and the Doppler velocity as dimensions and is formed by processing signals received by the radar sensor assigned to a respective time window and thus have spectral data that indicate matching targets; selecting at least one first selection range of the first signal spectrum; subdividing the first selection range in the dimension of the Doppler velocity into a plurality of first subranges; interpolating the spectral data of the first selection range of the first signal spectrum onto the first subranges; subdividing a second selection range indicating at least one target corresponding to the first selection range in the second signal spectrum in the dimension of the Doppler velocity into a plurality of second subranges; interpolating the spectral data of the second selection range of the second signal spectrum onto the second subranges; superposing the interpolated spectral data of the first and second selection range; expanding the first selection range of the first signal spectrum with the superposed interpolated spectral data; and outputting the thus expanded first signal spectrum.

This makes it possible to improve the Doppler separation capability of the radar sensor, in particular without increasing the thermal load on the radar sensor, reducing the acquisition performance for objects having high relative velocities, unduly increasing the memory requirements and the computing power, and/or increasing the latency of the radar sensor.

The radar sensor can be an FMCW radar sensor, in particular a linear chirp sequence frequency modulated continuous wave radar sensor.

The method of the present invention for increasing Doppler resolution can be carried out during operation of the radar sensor. Increasing the Doppler resolution can improve the Doppler separation capability. The Doppler separation capability improves as the Doppler resolution becomes smaller.

The Doppler resolution can indicate the smallest distance in the Doppler frequency between two targets that are acquired as still separated from one another via the Doppler frequency. An increase in the Doppler resolution can be a reduction of the distance.

The spectral data are preferably data in the frequency spectrum calculated from the signals received by the radar sensor in the time range using a Fast Fourier transformation (FFT). The spectral data can be specified as a spectral power density.

The first and/or second signal spectrum can be at least one distance Doppler velocity spectrum. In addition to these two dimensions, the first and/or second signal spectrum can have at least one further dimension, for example an azimuth angle or an elevation angle. The first and/or second signal spectrum can each be subdivided into bins expanded in the respective dimensions depending on a sampling of the signals received by the radar sensor.

Within a time window in which transmission signals are transmitted, a cyclic sequence of transmission signals can then be transmitted. Between the time windows, there is no transmission of transmission signals. The transmission signals can be respective spaced-apart frequency ramps (frequency chirps). A time window can include multiple frequency ramps.

According to an example embodiment of the present invention, the signals received by the radar sensor during a time window of the transmitted signals are processed to form the signal spectrum, in particular by means of coherent integration. A signal-to-noise ratio Z_t, depending on a number n of measured values of the received signal included in the coherent integration, is Z_t=Z_0+10log10(n). Z_0 is the signal-to-noise ratio of a measured value. For a number N of time windows with the respective number n of integrated measured values, the signal-to-noise ratio achieved using the proposed method is therefore Z=Z_t+10log10(N), and is thus approximately 3 dB higher for two time windows than for only one time window.

The second signal spectrum can be the most recently measured signal spectrum of the radar sensor. After the cycle time, when the method for increasing Doppler resolution is repeated, the previously second signal spectrum can form the first signal spectrum and the newly added signal spectrum can form the second signal spectrum. The update interval of the superposition of the integrated spectral data can thus correspond to the cycle time.

The selection range can also include the entire signal spectrum. The first selection range can be a section of the first signal spectrum limited to at least one distance bin in the distance dimension of the first signal spectrum. The first selection range can include the entire first signal spectrum.

The superposition can be a complex-valued addition.

The expanded first signal spectrum is formed at least by expanding the first selection range of the first signal spectrum with the superposed interpolated spectral data. The expanded first signal spectrum can be output in addition to the original first signal spectrum, in particular to a subsequent processing unit, for example a decoder.

In a preferred example embodiment of the present invention, it is advantageous if the spectral data of the first signal spectrum are calculated by processing signals received by the radar sensor assigned to a first time window and the spectral data of the second signal spectrum are calculated from signals received by the radar sensor assigned to a subsequent second time window. The signals received by the radar sensor result from reflections of the transmission signals in the surroundings of the radar sensor. The second time window can be arranged chronologically directly after the first time window.

In a special example configuration of the present invention, it is advantageous if a selection of the first selection range is dependent on an identification of relevant spectral data in the first signal spectrum. The selection can alternatively or additionally be made depending on a value of the distance dimension. The selection can be made based on the highest possible values of the distance dimension, i.e. targets that are as far away as possible. This can be particularly useful for increasing the signal-to-noise ratio of these spectral data.

The identification can be carried out by an acquisition unit of the radar sensor.

In a preferred example embodiment of the present invention, it is advantageous if the relevance of the spectral data is dependent on at least one main lobe width of at least one signal lobe in the distance dimension of the first signal spectrum. The relevance of the spectral data can also depend on at least one main lobe width of at least one signal lobe in the Doppler velocity dimension of the first signal spectrum.

An advantageous preferred example embodiment of the present invention is one in which the identification of relevant spectral data in the first signal spectrum takes place in the distance dimension or the distance dimension and the Doppler velocity dimension. The selection of the selection range can thus be selected depending on the available memory and computing power.

In a preferred example embodiment of the present invention, it is provided that the interpolation of the spectral data of the first and/or second selection range is a kernel interpolation. The kernel interpolation can use a Dirichlet kernel. During the interpolation, the subranges are filled with spectral data interpolated from the measured spectral data.

In a preferred example embodiment of the present invention, it is advantageous if a phase compensation of the interpolated spectral data of the second selection range is carried out prior to the superposition and after the interpolation of the spectral data of the second selection range. The phase compensation can be carried out by means of element-wise multiplication of the interpolated spectral data with a phase compensation matrix. The phase compensation can compensate a time offset between the spectral data of the first and second signal spectrum resulting from the temporal sequence of the time windows.

An advantageous preferred example embodiment of the present invention is one in which, of all the spectral data of the radar sensor, the superposed interpolated spectral data are based exclusively on the spectral data of the first and second signal spectrum. This makes it possible to achieve a compromise between the increase in the Doppler resolution and the additional memory and computing requirements.

Also provided according to the present invention is a method for operating a radar sensor. A method for operating the radar sensor, in which the acquisition unit is provided primarily or exclusively with expanded signal spectra calculated using a method for increasing Doppler resolution as already described, is provided as well.

The first and/or second signal spectrum can be calculated from the received signals and provided by a digital signal processing processor.

The present invention further provides a radar sensor.

Further advantages and advantageous example embodiments of the present invention will emerge from the description of the figures and the figures.

### BRIEF DESCRIPTION OF THE DRAWINGS

The present invention is described in detail in the following with reference to the figures.

FIG. 1 shows a method for increasing Doppler resolution in a specific example embodiment of the present invention.

FIG. 2 shows a method for increasing Doppler resolution in another specific example embodiment of the present invention.

FIG. 3 shows a comparison of Doppler velocity spectra.

FIG. 4 shows a method for operating a radar sensor in a specific example embodiment of the present invention.

### DETAILED DESCRIPTION OF EXAMPLE EMBODIMENTS

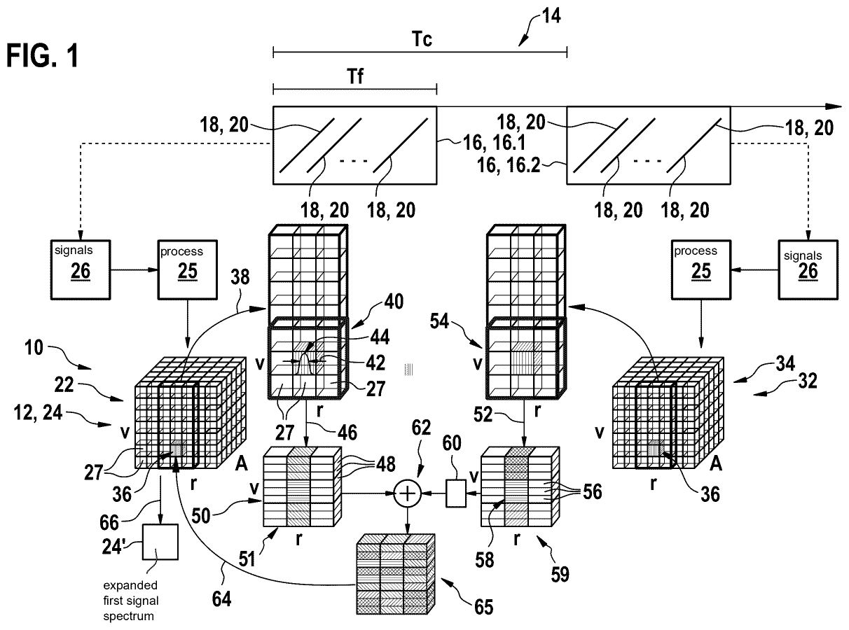

FIG. 1 shows a method for increasing Doppler resolution in a specific embodiment of the present invention. The method for increasing Doppler resolution 10 in a selection range of a signal spectrum 12 of a radar signal from a radar sensor is preferably carried out during operation of the radar sensor. The radar signal results from a cyclic sequence 14 of time windows 16 in which transmission signals 18 are transmitted. The radar sensor is preferably an FMCW radar sensor and the transmission signals 18 are frequency ramps 20, for example. A time window 16 can include multiple frequency ramps 20 and extend over a time period Tf. The signal is transmitted during the time period Tf of such a time window 16. After the end of a time window 16, a pause time elapses before the next time window 16 begins. This pause time is needed to enable a distinction between the transmission signals 18 from successive time windows 16 in the received signals and at the same time reduce the thermal load on the radar sensor. The cycle time Tc refers to the time period between the start of a time window 16 and the start of the next time window 16.

The method includes providing 22 at least one first signal spectrum 24 of the radar sensor, which is spanned by the distance r and the Doppler velocity v as dimensions, and also by an azimuth angle A as the third dimension. The first signal spectrum 24 is formed by processing 25, for example Fast Fourier transformation (FFT), of signals 26 received by the radar sensor assigned to the first time window 16.1. The first signal spectrum 24 can be subdivided into bins 27 expanded in the respective dimensions depending on a sampling of the signal 26 received by the radar sensor.

Also provided 32 is a second signal spectrum 34 of the radar sensor, which has the same dimensions as the first signal spectrum 24 and is formed by processing 25, for example by FTT, the signals 26 received by the radar sensor assigned to the second time window 16.2. The first and second signal spectrum 24, 34 each have spectral data 36 that indicate matching targets. Chronologically, the second time window 16.2 immediately follows the first time window 16.1.

At least a first selection range 40 of the first signal spectrum 24 is selected 38 as well. The selection 38 of the first selection range 40 is carried out depending on an identification of relevant spectral data 36 in the first signal spectrum 24 in the distance dimension r. The relevance of the spectral data 36 can depend on a main lobe width 42 of a signal lobe 44 of the spectral data 36 in the distance dimension of the first signal spectrum 24, for instance. The first selection range 40 is a section of the first signal spectrum 24 limited to three bins 27 in the distance dimension r, for example, and three bins 27 in the dimension of the Doppler velocity dimension v of the first signal spectrum 24.

This is followed by subdividing 46 the first selection range 40 in the dimension of the Doppler velocity v into a plurality of first subranges 48. The first selection range 40 in the Doppler velocity dimension v is subdivided here into three times as many subranges 48 as there are bins 27 in the Doppler velocity dimension v in the first selection range 40 prior to subdividing 46.

There is also an interpolation 50 of the spectral data of the first selection range 40 of the first signal spectrum 24 onto the first subranges 48, which results in interpolated spectral data 51. The interpolation 50 can be a kernel interpolation using a kernel, for example a Dirichlet kernel.

A subdivision 52 of second selection range 54 indicating at least one target corresponding to the first selection range 40 in the second signal spectrum 34 in the dimension of the Doppler velocity v into a plurality of second subranges 56 and an interpolation 58 of the spectral data of the second selection range 54 of the second signal spectrum 34 onto the second subranges 56 are carried out as well, which results in interpolated spectral data 59.

A subsequent phase compensation 60 of the interpolated spectral data 59 of the second selection range 54 compensates a time offset between the interpolated spectral data 51 of the first selection range 40 and the interpolated spectral data 59 of the second selection range 54.

This is followed by superposing 62 the interpolated spectral data 51, 59, expanding 64 the first selection range 40 of the first signal spectrum 24 with the superposed interpolated spectral data 65, and outputting 66 the thus expanded first signal spectrum 24′.

Of all of the spectral data 36 of the radar sensor, the superposed interpolated spectral data 65 can be based exclusively on the spectral data 36 of the first and second signal spectrum 24, 34.

The method has been explained here using a first selection range 40 of the first signal spectrum 24 as an example, but can also be carried out for further first selection ranges in the first signal spectrum 24 and corresponding second selection ranges 54 in the second signal spectrum 34.

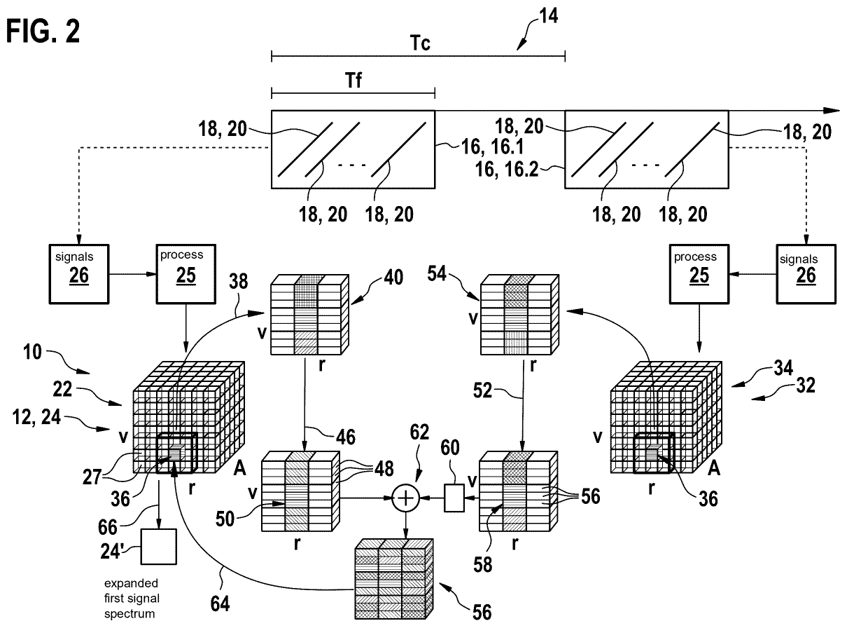

FIG. 2 shows a method for increasing Doppler resolution in another specific embodiment of the present invention. The method for increasing Doppler resolution 10 is the same as that of FIG. 1, including the description with the reference signs, except for following differences. The identification of relevant spectral data 36 in the first signal spectrum 24 is carried out in the distance dimension r and in the Doppler velocity dimension v.

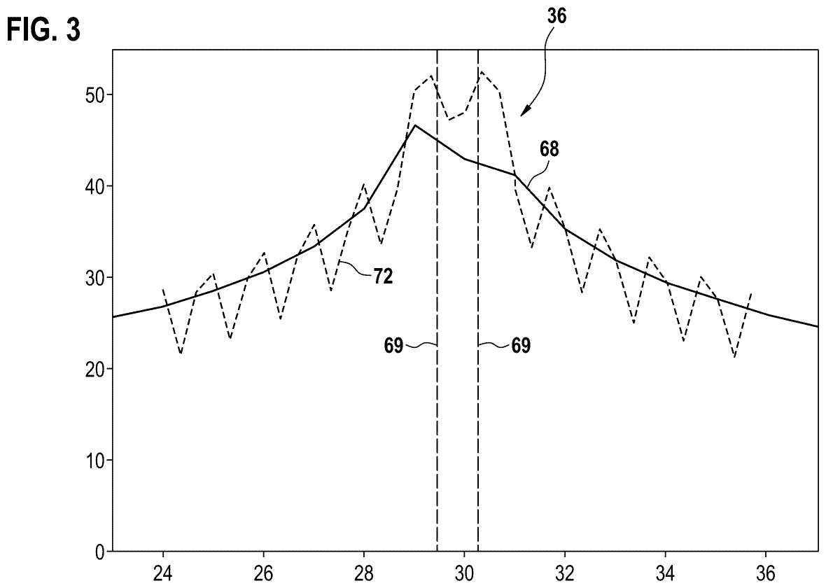

FIG. 3 shows a comparison of Doppler velocity spectra. The graph shows spectral data 36 as a curve of a power density in dB over a number of bins in the Doppler velocity dimension of a signal spectrum of the radar sensor. A first curve 68 indicates the spectral data of a single time window. The actual targets are spaced apart from one another over a distance of 0.8 bins corresponding to the vertical lines 69. With the first curve 68, the two targets cannot be separated in the Doppler velocity dimension.

However, by applying the method for increasing Doppler resolution using the superposed interpolated spectral data, a second curve 72 is calculated that distinguishes the two targets from one another.

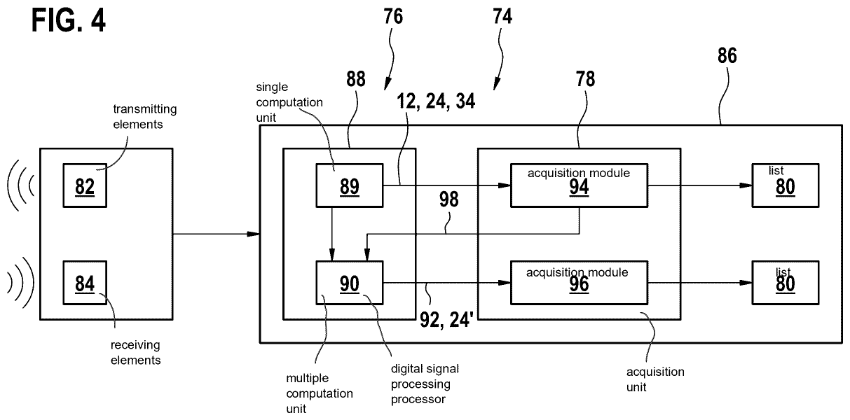

FIG. 4 shows a method for operating a radar sensor in a specific embodiment of the present invention. The method for operating 74 a radar sensor 76 comprises providing the radar sensor 76 with at least one acquisition unit 78 for acquiring targets in signal spectra of the radar signal of the radar sensor 76 resulting from a cyclic sequence of time windows in which transmission signals are transmitted. The acquisition unit 78 can output a list 80 of acquired targets depending on the acquisition.

The radar sensor 76 comprises transmitting elements 82 for transmitting the radar signals and receiving elements 84 for receiving the radar signals. The received signals are fed to a digital processing unit 86, which comprises the acquisition unit 78 and is a microprocessor, for instance.

The processing unit 86 comprises a digital signal processing processor 88 which, in a single computation unit 89, calculates and provides the signal spectra including the first and second signal spectrum 24, 34 from the received signals for each time window, and, in a multiple computation unit 90, calculates and provides signal spectra expanded using the data of multiple time windows as described with the method for increasing Doppler resolution, including the first expanded signal spectrum 24′. The single computation unit 89 outputs the signal spectra 12 and the multiple computation unit 90 outputs the expanded signal spectra 92 to the acquisition unit 78 at the same time. In parallel with an acquisition module 94, for instance, it calculates a list 80 of acquired targets from the signal spectra 12, and, in parallel with an acquisition module 96, a list of acquired targets from the expanded signal spectra 92.

The identification 98 of relevant spectral data for selecting the first selection range can be carried out by the acquisition module 96 using the signal spectra.

What is claimed is:

1. A method for increasing Doppler resolution in a selection range of a signal spectrum of a radar signal from a radar sensor resulting from a cyclic sequence of time windows in which transmission signals are transmitted, the method comprising the following steps:
providing at least a first and second signal spectrum of the radar sensor, each of which is spanned at least by a distance and a Doppler velocity as dimensions and is formed by processing signals received by the radar sensor assigned to a respective time window and have spectral data that indicate matching targets;
selecting at least one first selection range of the first signal spectrum;
subdividing the first selection range in the dimension of the Doppler velocity into a plurality of first subranges;
interpolating the spectral data of the first selection range of the first signal spectrum onto the first subranges;
subdividing a second selection range indicating at least one target corresponding to the first selection range in the second signal spectrum in the dimension of the Doppler velocity into a plurality of second subranges;
interpolating the spectral data of the second selection range of the second signal spectrum onto the second subranges;
superposing the interpolated spectral data of the first and second selection range;
expanding the first selection range of the first signal spectrum with the superposed interpolated spectral data; and
outputting the expanded first signal spectrum.

2. The method for increasing Doppler resolution according to claim 1, wherein the spectral data of the first signal spectrum are calculated by processing signals received by the radar sensor assigned to a first time window and the spectral data of the second signal spectrum are calculated by processing signals received by the radar sensor assigned to a subsequent second time window.

3. The method for increasing Doppler resolution according to claim 1, wherein the selection of the first selection range is dependent on an identification of relevant spectral data in the first signal spectrum.

4. The method for increasing Doppler resolution according to claim 3, wherein the relevance of the spectral data is dependent on at least one main lobe width of at least one signal lobe in the distance dimension of the first signal spectrum.

5. The method for increasing Doppler resolution according to claim 3, wherein the identification of relevant spectral data in the first signal spectrum takes place in: (i) the distance dimension or (ii) the distance dimension and the Doppler velocity dimension.

6. The method for increasing Doppler resolution according to claim 1, wherein the interpolation of the spectral data of the first and/or second selection range is a kernel interpolation.

7. The method for increasing Doppler resolution according to claim 1, wherein a phase compensation of the interpolated spectral data of the second selection range is carried out prior to the superposition and after the interpolation of the spectral data of the second selection range.

8. The method for increasing Doppler resolution according to claim 1, wherein of all the spectral data of the radar sensor, the superposed interpolated spectral data are based exclusively on the spectral data of the first and second signal spectrum.

9. A method for operating a radar sensor, comprising the following steps:
providing the radar sensor with at least one acquisition unit configured to acquire targets in signal spectra of the radar signal of the radar sensor resulting from a cyclic sequence of time windows in which transmission signals are transmitted;
providing at least a first and second signal spectrum of the radar sensor, each of which is spanned at least by the distance and the Doppler velocity as dimensions and is formed by processing signals received by the radar sensor assigned to a respective time window and have spectral data that indicate matching targets;
outputting the first signal spectrum and at the same time the first signal spectrum expanded by a method for increasing Doppler resolution of a Doppler resolution to the acquisition unit.

10. A radar sensor configured to generate a radar signal resulting from a cyclic sequence of time windows in which transmission signals are transmitted, and configured to increase Doppler resolution in a selection range of a signal spectrum of the radar signal resulting from the cyclic sequence of time windows in which the transmission signals are transmitted, by:
providing at least a first and second signal spectrum of the radar sensor, each of which is spanned at least by a distance and a Doppler velocity as dimensions and is formed by processing signals received by the radar sensor assigned to a respective time window and have spectral data that indicate matching targets;
selecting at least one first selection range of the first signal spectrum;
subdividing the first selection range in the dimension of the Doppler velocity into a plurality of first subranges;
interpolating the spectral data of the first selection range of the first signal spectrum onto the first subranges;
subdividing a second selection range indicating at least one target corresponding to the first selection range in the second signal spectrum in the dimension of the Doppler velocity into a plurality of second subranges;
interpolating the spectral data of the second selection range of the second signal spectrum onto the second subranges;
superposing the interpolated spectral data of the first and second selection range;
expanding the first selection range of the first signal spectrum with the superposed interpolated spectral data; and
outputting the expanded first signal spectrum.
